(19) United States
(12) Patent Application Publication
(10) Pub. No.: US 2015/0114862 A1
(43) Pub. Date: Apr. 30, 2015

(54) SAFETY DEVICE FOR TOOL DISPLAY TAG

(71) Applicant: GONG FONG ENTERPRISE CO., LTD., Tainan City (TW)

(72) Inventor: Cheng-Te HU, Tainan City (TW)

(73) Assignee: GONG FONG ENTERPRISE CO., LTD., Tainan City (TW)

(21) Appl. No.: 14/064,931

(22) Filed: Oct. 28, 2013

(51) Int. Cl. B65D 73/00; B25H 3/00

(52) U.S. Cl. CPC B65D 73/0064; B25H 3/003
USPC 206/349; 206/481; 206/1.5

(57) ABSTRACT

A safety device for a tool display tag includes a first part having a first groove, and multiple first clamp members extend from the inside of the first groove. The first part has multiple positioning holes and multiple through holes through which bolts extend. A second part is fixed to the first part and has a second groove located corresponding to the first groove. Multiple second clamp members extend from the inside of the second groove. The second part has multiple positioning rods and multiple threaded holes. The positioning rods are inserted into the positioning holes and the bolts are threadedly connected to the threaded holes. A tag is connected to the first part. A tool is safely secured between the first and second parts.

### FIELD OF THE INVENTION

The present invention relates to a tool display tag, and more particularly, to an anti-theft tool display tag which is securely connected to the tool.

### BACKGROUND OF THE INVENTION

A conventional hand tool tag is used for displaying the specifications of the tool and for convenience of advertising the tool. One of the conventional tool display tags is disclosed in Taiwan Utility Model No. M436401 published on Sep. 1, 2012, and generally comprises a display seat which is able to be shifted between a planar display position and a stereoscopic display position. The display seat comprises a display unit and a connection unit. The display unit has two separated side panels to which the precision tool is installed and at least one bendable connection board which is connected between the two side panels, so that the precision tool is connected to the connection board. The connection unit is connected to the side panels of the display unit. When the precision tool is located at the stereoscopic position, the precision tool is removably connected to the side panels, so that the precision tool is able to be shifted between the planar display position and the stereoscopic display position as needed.

However, the side panels do not have any fixing mechanism for securing the tool that is displayed, so that the displayed tool may be easily stolen or taken away without authorization.

Taiwan Utility Model No. M431789 is published on Jun. 21, 2012 and discloses another tool parts display tag which securely connects the parts from lateral sides so as to have the safety feature, and the display tag generally comprises a rack for the parts, and a restriction unit. When the tool parts are connected to the rack, the cover and the seat of the restriction unit are connected to each other from the lateral sides of the parts. The ribs on the inside of the cover and the seat are engaged with recesses located on the lateral sides of the parts such that the parts are securely positioned between the cover and the seat.

When the cover and the seat are connected to each other, the connection is made by engaging resilient hooks and the lugs to securely position the parts such as sockets by the restriction unit. Nevertheless, the resilient hooks cause gaps between the resilient hooks and the lugs, and the sockets can be easily pulled away.

The present invention intends to provide a safety device for a tool display tag so as to improve the shortcomings mentioned above.

### SUMMARY OF THE INVENTION

The present invention relates to a safety device for a tool display tag and comprises a first part having a first groove, and multiple first clamp members extend from the inside of the first groove. The first part has multiple positioning holes and multiple through holes through which bolts extend. A second part is fixed to the first part and has a second groove located corresponding to the first groove. Multiple second clamp members extend from the inside of the second groove. The second part has multiple positioning rods and multiple threaded holes. The positioning rods are inserted into the positioning holes and the bolts are threadedly connected to the threaded holes. A tag is connected to the first part. A tool is safely secured between the first and second parts.

Preferably, the first part has a protrusion, and the tag has an engaging hole through which the protrusion extends.

Preferably, the tag is integrally connected to the first part.

Preferably, the second part has an opening which communicates with the second groove.

Preferably, the tag has a hang hole.

The advantages of the present invention are that the tool can be safely secured between the first and second parts by using bolts extending through the through holes and connected to the threaded holes. The tool is protected from being taken away without permission.

The first and second clamp members in the first and second grooves contact the tool to firmly secure the tool to prevent the tool from being stolen.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the safety device of the present invention;

FIG. 2 shows that a tool is connected with the safety device of the present invention;

FIG. 3 is a cross sectional view to show the tool connected with the safety device of the present invention;

FIG. 4 is a perspective view to show that the tool is displayed by the safety device of the present invention;

FIG. 5 is an exploded view to show another embodiment of the safety device of the present invention;

FIG. 6 is a cross sectional view to show the embodiment of the safety device of the present invention in FIG. 5, and

FIG. 7 is a perspective view to show that a tool is displayed by the safety device of the present invention in FIG. 5.

### DETAILED DESCRIPTION OF THE PREFERRED EMBODIMENT

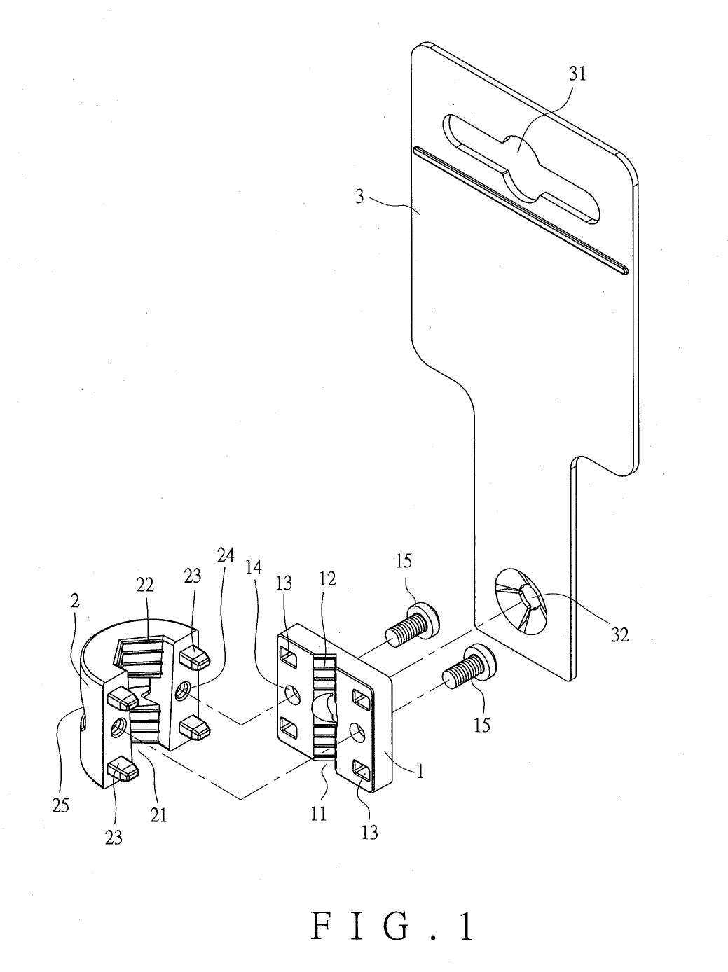

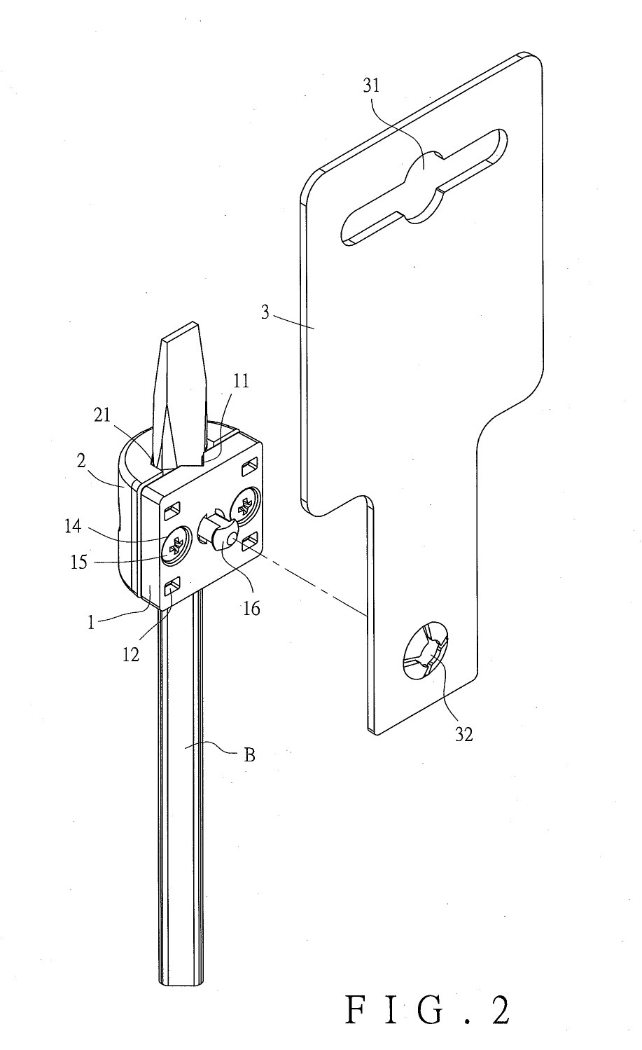

Referring to FIGS. 1 and 2, the safety device for a tool display tag of the present invention comprises a first part 1, a second part 2 and a tag 3.

The first part 1 has a first groove 11 on the front side thereof, and multiple first clamp members 12 extend from the inside of the first groove 11. The first part 1 has multiple positioning holes 13 and multiple through holes 14. Bolts 15 extend through the through holes 14. A protrusion 16 extends from the rear side of the first part 1.

The second part 2 is fixed to the first part 1 and has a second groove 21 which is located corresponding to the first groove 11. Multiple second clamp members 22 extend from the inside of the second groove 21. The second part 2 has multiple positioning rods 23 and multiple threaded holes 24. The positioning rods 23 are inserted into the positioning holes 13 and the bolts 15 are threadedly connected to the threaded holes 24. The second part 2 has an opening 25 which communicates with the second groove 21.

The tag 3 is connected to the first part 1. The tag 3 has a hang hole 31 and an engaging hole 32 which can be resiliently expanded outward. The protrusion 16 extends through the engaging hole 32.

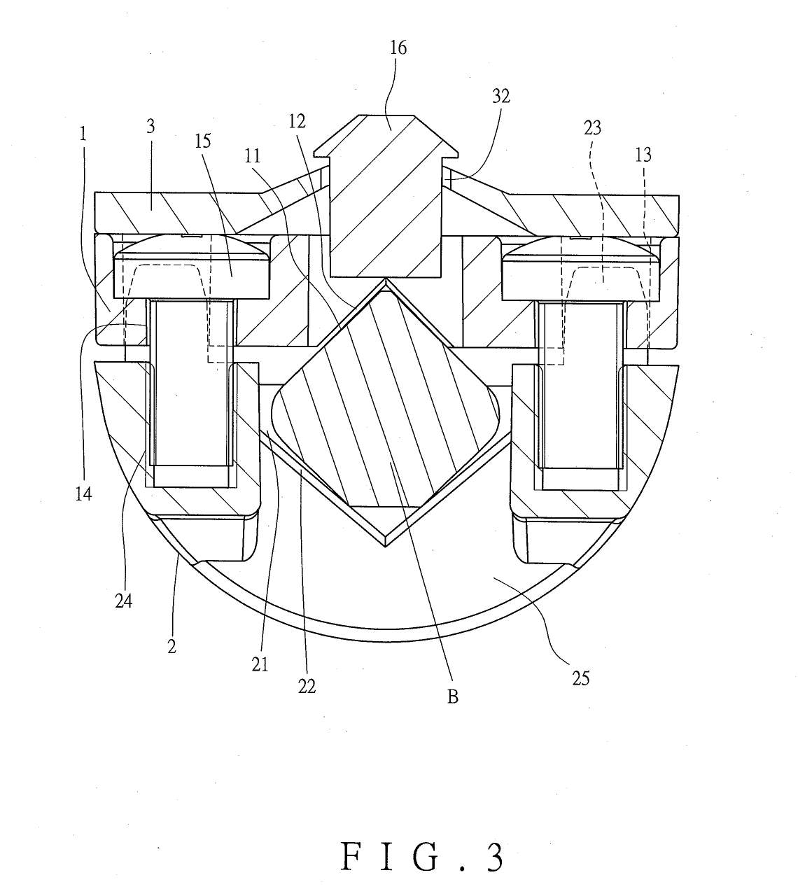

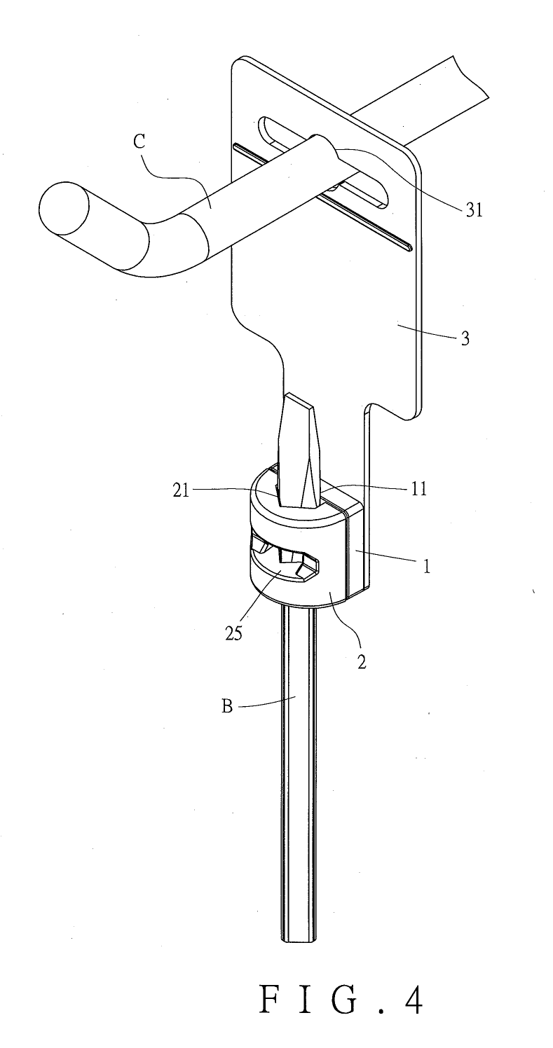

When in use, as shown in FIGS. 2 and 3, a tool B is put in the first groove 11 of the first part 1 and contacts against the first clamp members 12. The positioning rods 23 of the second part 2 are inserted into the positioning holes 13 of the first part 1 to position the tool B between the first and second grooves 11, 21. The second clamp members 22 contact against the tool B. The bolts 15 extend through the through holes 14 and are connected to the threaded holes 24, so that the tool B is clamped by the first and second parts 1, 2, and the first and second clamp members 12, 22 contact against the tool B. The tool B cannot be taken out from the first and second grooves 11, 21. The tool B can be clearly seen that the tool B is securely clamped via the opening 25. The protrusion 16 on the rear side of the first part 1 is inserted into the engaging hole 321 so that the first part 1 can be fixed to the tag 3. The tag 3 is then hanged on a hook C by the hang hole 31 as shown in FIG. 4 so as to display the tool B. The tool B is clamped by the first and second parts 1, 2 so that the tool B is prevented from being stolen.

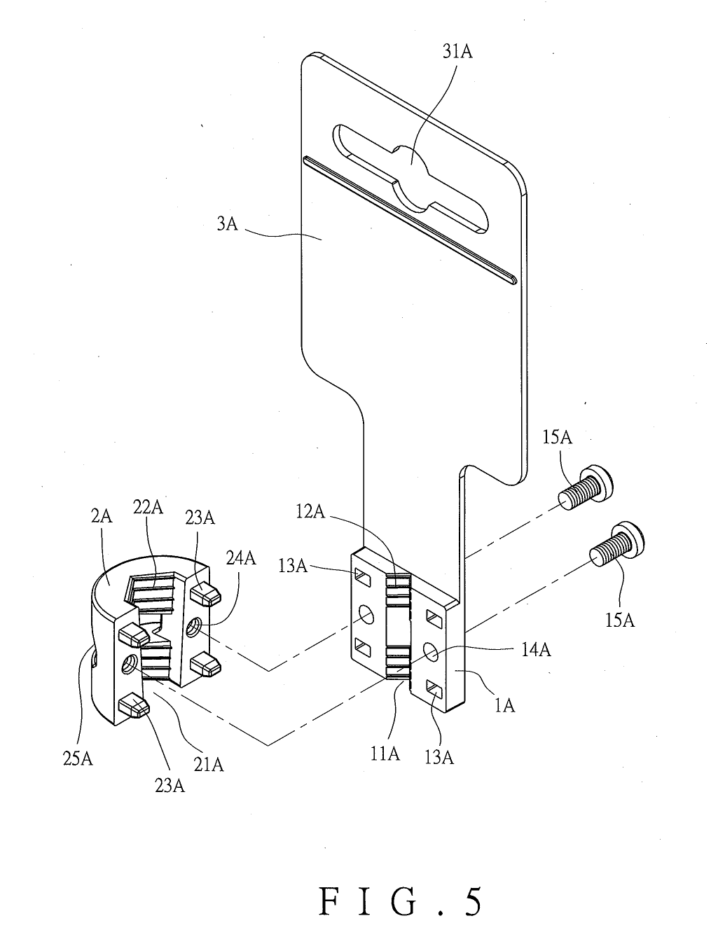

FIG. 5 shows another embodiment, wherein the first part 1A has a first groove 11A on the front side thereof, and multiple first clamp members 12A extend from the inside of the first groove 11A. The first part 1A has multiple positioning holes 13A and multiple through holes 14A. Bolts 15A extend through the through holes 14A.

The second part 2A is fixed to the first part 1A and has a second groove 21A which is located corresponding to the first groove 11A. Multiple second clamp members 22A extend from the inside of the second groove 21A. The second part 2A has multiple positioning rods 23A and multiple threaded holes 24A. The positioning rods 23A are inserted into the positioning holes 13A and the bolts 15A are threadedly connected to the threaded holes 24A. The second part 2A has an opening 25A which communicates with the second groove 21A.

The tag 3A is integrally connected to the first part 1A and has a hang hole 31A.

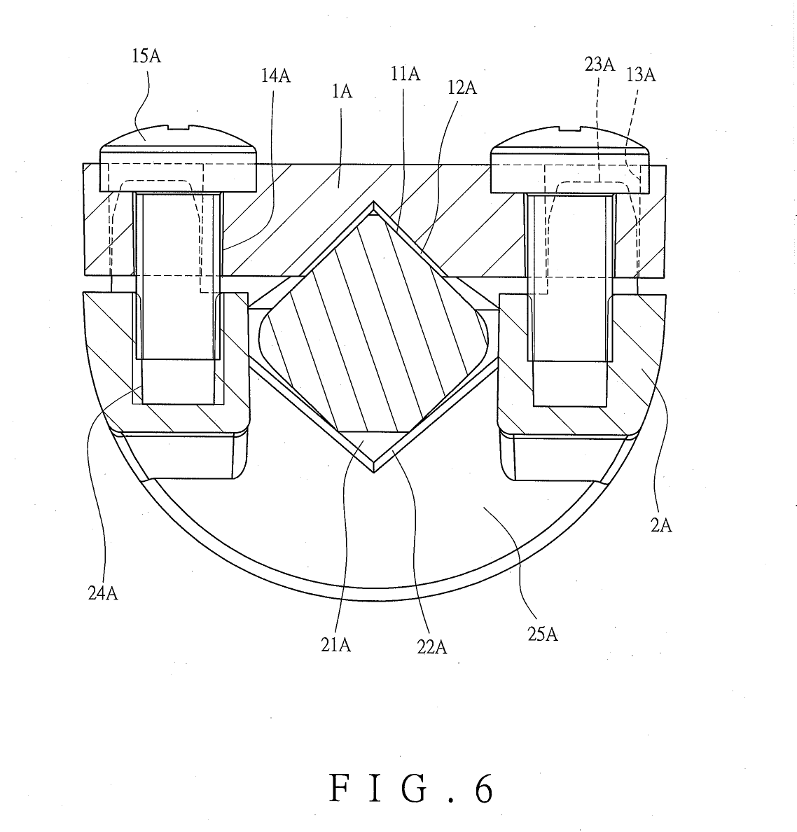

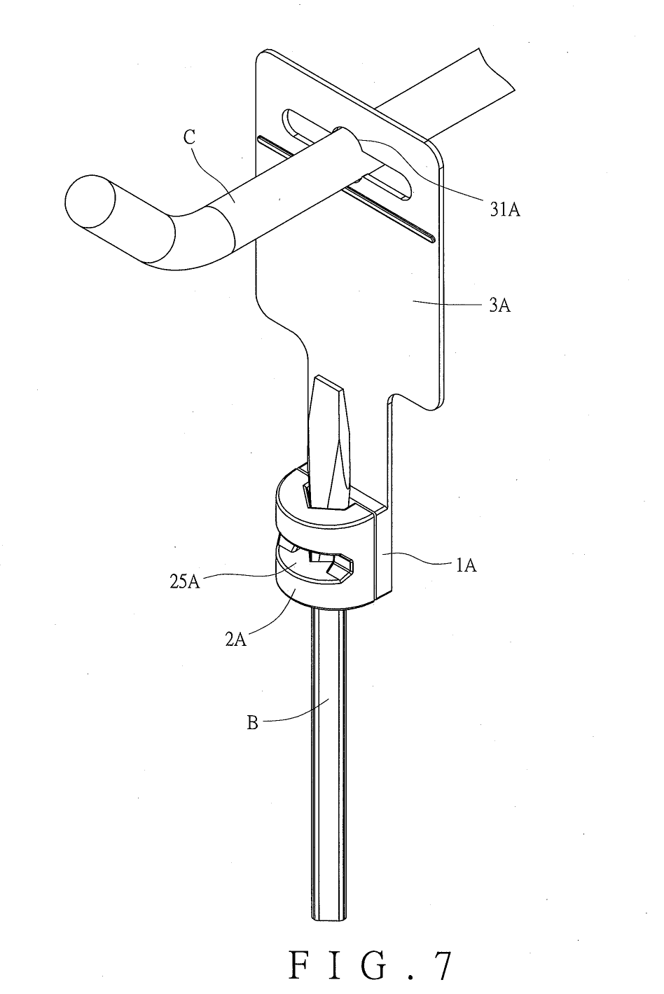

When in use, as shown in FIGS. 6 and 7, a tool B is put in the first groove 11A of the first part 1A and contacts against the first clamp members 12A. The positioning rods 23A of the second part 2A are inserted into the positioning holes 13A of the first part 1A. The bolts 15A extend through the through holes 14A and are connected to the threaded holes 24A. The first and second clamp members 12A, 22A contact against the tool B. The tag 3A is then hanged on a hook C by the hang hole 31A so as to display the tool B. The tool B is clamped by the first and second parts 1A, 2A so that the tool B is prevented from being stolen.

While we have shown and described the embodiment in accordance with the present invention, it should be clear to those skilled in the art that further embodiments may be made without departing from the scope of the present invention.

What is claimed is:

1. A safety device for a tool display tag comprising:
a first part having a first groove, multiple first clamp members extending from an inside of the first groove, the first part having multiple positioning holes and multiple through holes, bolts extending through the through holes;
a second part fixed to the first part and having a second groove which is located corresponding to the first groove, multiple second clamp members extending from an inside of the second groove, the second part having multiple positioning rods and multiple threaded holes, the positioning rods inserted into the positioning holes and the bolts being threadedly connected to the threaded holes, and
a tag connected to the first part.

2. The safety device as claimed in claim 1, wherein the first part has a protrusion, and the tag has an engaging hole through which the protrusion extends.

3. The safety device as claimed in claim 1, wherein the tag is integrally connected to the first part.

4. The safety device as claimed in claim 1, wherein the second part has an opening which communicates with the second groove.

5. The safety device as claimed in claim 1, wherein the tag has a hang hole.
